(19) United States
(12) Patent Application Publication
(10) Pub. No.: US 2014/0351947 A1
(43) Pub. Date: Nov. 27, 2014

(54) METHOD OF GENERATING EXECUTION FILE FOR MOBILE DEVICE, METHOD OF EXECUTING APPLICATION OF MOBILE DEVICE, DEVICE TO GENERATE APPLICATION EXECUTION FILE, AND MOBILE DEVICE

(71) Applicant: SAMSUNG Electronics Co., Ltd., Suwon-si (KR)

(72) Inventors: Woo-chul SHIM, Iksan-si (KR); Moon-gyu JUNG, Seoul (KR)

(73) Assignee: SAMSUNG Electronics Co., Ltd., Suwon-si (KR)

(21) Appl. No.: 14/283,456

(22) Filed: May 21, 2014

(30) Foreign Application Priority Data
May 27, 2013 (KR) 10-2013-0060000

(51) Int. Cl. G06F 21/12

(52) U.S. Cl. CPC G06F 21/12
USPC 726/26

(57) ABSTRACT

A method of generating an application execution file for a mobile device is provided. The method according to an exemplary embodiment of the present invention includes encoding at least one class, which requires security, independently of other classes among a plurality of classes to execute an application, and generating the application execution file which includes the encoded at least one class and the other classes.

### CROSS-REFERENCE TO RELATED APPLICATIONS

This application claims priority under 35 U.S.C. 119(a) Korean Patent Application No. 10-2013-0060000, filed on May 27, 2013 in the Korean Intellectual Property Office, the disclosure of which is incorporated herein by reference in its entirety.

### BACKGROUND OF THE INVENTION

1. Field of the Invention

The present general inventive concept relates to a method of generating an application execution file for a mobile device, and more specifically, to a method of generating an application execution file for a mobile device with increased and/or enhanced security, a method of executing an application of a mobile device, a device to generate an application execution file, and a mobile device.

2. Description of the Related Art

With types of mobile services diversified, high-security information is increasingly transmitted and received between a mobile device and a service provider. For example, an online payment application may provide a service server with credit card information of a user, and may further transmit a user password to the server so as to receive a service from the server.

However, a mobile device has relatively vulnerable security, compared to a personal computer, and cases of using security vulnerability of a mobile device for hacking are increased.

One of the reasons for a vulnerable security of a mobile device is that the security environment of a mobile device lags behind the pace of web services spreading rapidly to the mobile device from the personal computer. Particularly, what is more problematic is that since the mobile device has a limited performance of hardware, and thus is required to have a relatively small data throughput of software, most of the applications installed in the mobile device are written in a programming language that is easy to develop and lightweight.

For example, an application for an Android operating system (OS) is written, in most cases, in a JAVA language so as to be developed easily. However, such applications written in JAVA have vulnerable security, as the JAVA language has a characteristic that makes it easy to obtain a source code through decompiling. FIG. 1 is a view illustrating an original application 10 written in JAVA, and a modified application 20. That is, the modified application 20 is written by hacking the application 10 written in the JAVA language. As illustrated in FIG. 1, the application may include a portion 11 written in a managed code, such as a JAVA language, and a portion 12 written in a Native Code, such as the C language. Most of the applications executed in the Android OS are written in a JAVA language.

Herein, the managed code (i.e., portion 11 of application 10) refers to a source code written in a type of programming language in which an execution program manages by itself a memory to execute a program. An example of such code is a source code written in JAVA, C#, etc. In the case of JAVA, a Garbage Collector manages a memory without involvement from a user. The managed code (i.e., portion 11 or application 10) requires another program called an interpreter so as to execute a program. Examples of such interpreter include a JAVA Virtual Machine (JVM) or a .Net Framework.

The Native Code (i.e., portion 12 of application 10) refers to a source code written in a type of programming language in which a programmer is required to directly input a code to manage a memory. That is, the programmer must manage memory by the design of the source code. An example of such code is a source code written in C, C++, etc. The Native Code (i.e., portion 12 of application 10) has a characteristic that a compiled file is directly executed on a computer without any separate execution program.

However, a program written in the managed code (i.e., portion 11 of application 10), such as JAVA, has a vulnerable security, since a source code can be easily obtained by decompiling. That is, by decompiling, a hacker may easily obtain a source code from which information that requires security can be stolen. Further, a changed code 21 of the modified application 20 can also be written using the obtained source code, and as a result, the changed code 21, which includes a malicious code, can be a secondary damage to a user. Such fake or modified applications may be distributed in the black market.

FIG. 2 is a view illustrating a JAVA source code extracted by decompiling.

As illustrated in FIG. 2, a source code can be obtained from a compiled JAVA code by unzipping an application, converting a dex file (i.e., a Dalvik Executable file of Android) to a jar file (i.e., a Java ARchive file, which is an archive file format) using dex2jar, and decompiling the jar file. The source code obtained includes logic for a user to set an encryption key.

Unlike the managed code (i.e., the portion 11 of application 10 illustrated in FIG. 1), which has a vulnerable security due to easy decompiling, a compiled source is hard extract from an application written in the Native code (i.e., the portion 12 of application 10 illustrated in FIG. 1), thereby allowing a relatively enhanced security. For this reason, a finance-related application or an application handling personal information is rewritten in the Native code for portions that require security during the development process. For such applications, a technique is used in which some classes written in JAVA in the Android OS environment are rewritten in the Native code, such as a C language, using Java Native Interface (JNI). However, such development has the following problem, as illustrated in FIG. 3 and described below.

FIG. 3 is a view illustrating a problem in the case where an application rewritten in the Native code is executed in the Android OS.

As illustrated in FIG. 3, an application file 30, which is written in JAVA and compiled, includes a classes.dex file 31 having classes for execution. As a source of the classes.dex file 31 can be exposed through decompiling, some important classes are rewritten in C code using JNI. That is, particular classes in libraries 37 are rewritten in C code from JAVA. The classes.dex file 36 of the application 35 may include a portion that invokes an application program interface (API) provided by a Native Lib (i.e., a native library). Some important classes are conducted in the Native. Lib.

However, such type of coding, where there is development of an application in JAVA, with important classes written in C code, causes delays in developing periods of applications, and increases the burden on an application developer. Furthermore, such development with two different languages and coordination between the two codesets increases bugs (i.e., errors, flaws, or failures in an application), thereby degrading a stable performance of an application.

### SUMMARY OF THE INVENTION

Therefore, there is a need to reduce and/or eliminate security vulnerability without rewriting all or portions of an application written in a managed code into a native code. The execution file thus generated can be operated effectively in a mobile device and/or computing device, as well as minimize and/or eliminate a resource overhead.

The present general inventive concept provides a method of generating an application execution file and a device to generate an application execution file, which reduces and/or eliminates security vulnerability without rewriting portions of an application written in a managed code into a Native code.

The present general inventive concept also provides a mobile device in which the execution file thus generated can be operated effectively without overhead, and a method of executing an application.

Additional features and utilities of the present general inventive concept will be set forth in part in the description which follows and, in part, will be obvious from the description, or may be learned by practice of the general inventive concept.

One or more exemplary embodiments provide a method of generating an application execution file for a mobile device, which includes encoding at least one class, which requires security, independently of other classes among a plurality of classes with an encoder of the mobile device to execute the application, and generating the application execution file which includes the encoded at least one class and the other classes with an application generator of the mobile device.

One or more exemplary embodiments also provide a method of generating an application execution file for a mobile device, in which the encoding may include compiling a plurality of classes to execute the application, and encoding the at least one class, which requires security, separately from the other classes among the plurality of compiled classes.

One or more exemplary embodiments also provide a method of generating an application execution file for a mobile device, which may further include generating protection class information including information on the at least one class which requires security, and generating a protection module to identify the at least one class which requires security by reference to the generated protection class information, when executing the application.

Exemplary embodiments of the present general inventive concept may provide a method of executing an application of a mobile device, which includes identifying at least one class which requires security when receiving a command to execute the application, decoding the identified at least one class with a decoder of the mobile device, and dynamically loading the decoded at least one class.

The identifying at least one class may identify the at least one class which requires security according to protection class information.

The decoding the identified at least one class may decode the identified at least one class using a key included in a protection module of the application.

Exemplary embodiments of the present general inventive concept provide a device to generate an application execution file, which includes an encoder to encode at least one class, which requires security, independently of other classes among a plurality of classes for executing an application, an execution file generator to generate the application execution file which includes the encoded at least one class and the other classes.

The encoder may include a compiler to compile a plurality of classes to execute the application, and a class encoder to encode the at least one class, which requires security, separately from the other classes among the plurality of compiled classes.

The execution file generator includes a protection module generator to generate a protection module to identify the at least one class which requires security by reference to the protection class information.

Exemplary embodiments of the present general inventive concept provide a mobile device, which includes class identificator to identify at least one class which requires security among a plurality of application classes of an application, when receiving an application execute command with the mobile device, a decoder to decode the identified at least one class, and a loader to dynamically load the decoded at least one class.

The class identificator may identify the at least one class which requires security according to protection class information.

The decoder may decode the identified at least one class using a key included in a protection module of the application.

Exemplary embodiment s of the present general inventive concept may provide a mobile device including an interpreter to identify at least one class which requires security among a plurality of application classes of an application, when receiving an application execute command with the mobile device, to decode the identified at least one class, and to dynamically load the decoded at least one class.

Exemplary embodiments of the present general inventive concept may also provide a computing device including an encoder to determine a least one class, from a plurality of classes, which requires security for an application execution file to be generated by the computing device, and to encode the determined at least one class which requires security independently of other classes among the plurality of classes, and an execution file generator to generate the application execution file which includes the encoded at least one class and the other classes.

Exemplary embodiments of the present general inventive concept may also provide a computing device including a processor to identify at least one class which requires security among a plurality of application classes of a selected application to be executed by the computing device upon receiving an execution command, a decoder to decode the identified at least one class that requires security, and a loader to dynamically load the decoded at least one class, where the processor executes the selected application according to the plurality of application classes and the decoded at least one class that requires security that is dynamically loaded.

According to various embodiments of the present general inventive concept as mentioned above, the present general inventive concept provides a method of generating an application execution file and a device to generate an application execution file, so as to minimize and/or prevent security vulnerability without rewriting an application written in a managed code into a Native code. Further, the execution file thus generated can be executed effectively in a mobile device and/or computing device without overhead.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating a modified application which is written by hacking an application written in a JAVA language;

FIG. 2 is a view illustrating a JAVA source code extracted by decompiling;

FIG. 3 is a view illustrating a problem raised in the case of coding the application to be operated in an Android OS;

FIGS. 4A, 4B, and 5 are block diagrams illustrating an example of a device to generate an application execution file according to an exemplary embodiment of the present general inventive concept;

FIG. 6 is a schematic view illustrating an example of generating an execution file which includes an encoded class;

FIGS. 7 and 8 are views illustrating an executing screen of a tool to generate an execution file including an encoded JAVA class;

FIGS. 9A and 9B are block diagrams illustrating examples of a mobile device according to exemplary embodiments of the present general inventive concept;

FIG. 10 is a flow chart illustrating an operation of the mobile device;

FIG. 11 is a schematic view illustrating an example of writing a class to be protected in a Native Code;

FIGS. 12 and 13 are flow charts illustrating examples of methods of generating an application execution file for a mobile device according to various embodiments of the present general inventive concept; and

FIGS. 14 and 15 are flow charts illustrating examples of methods of executing an application of a mobile device according to various embodiments of the present general inventive concept.

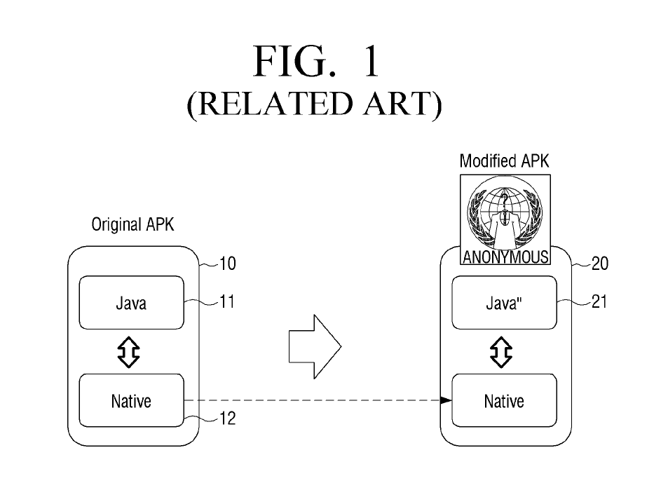

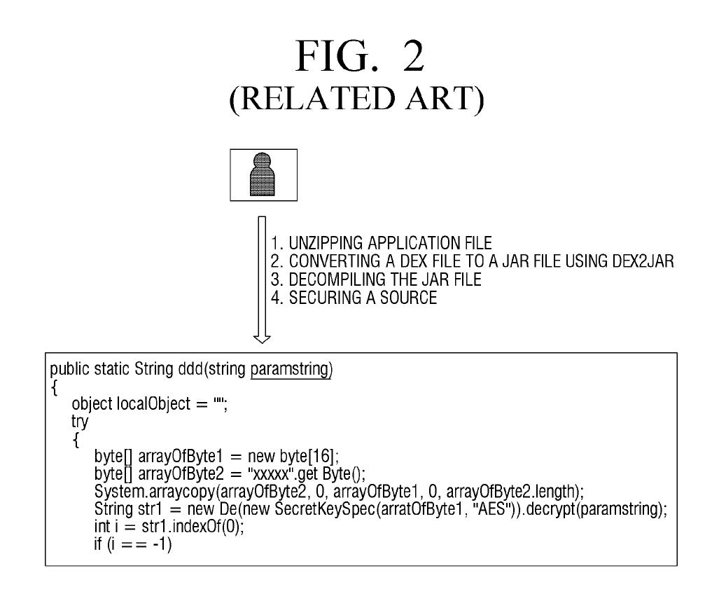

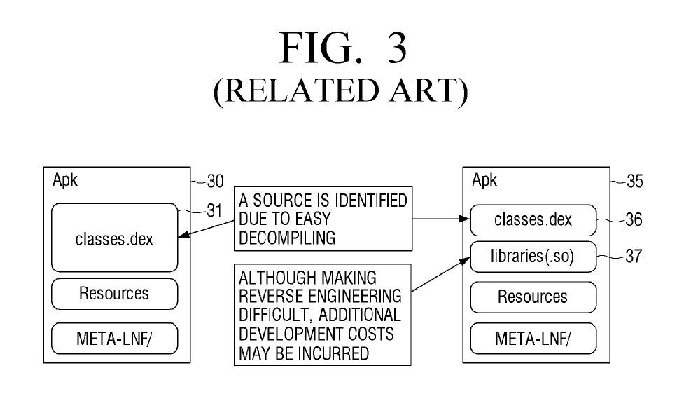

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

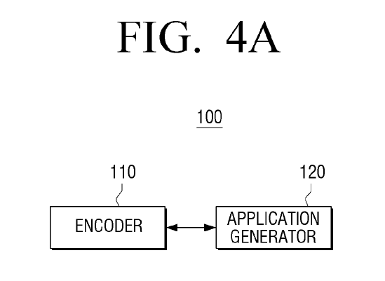

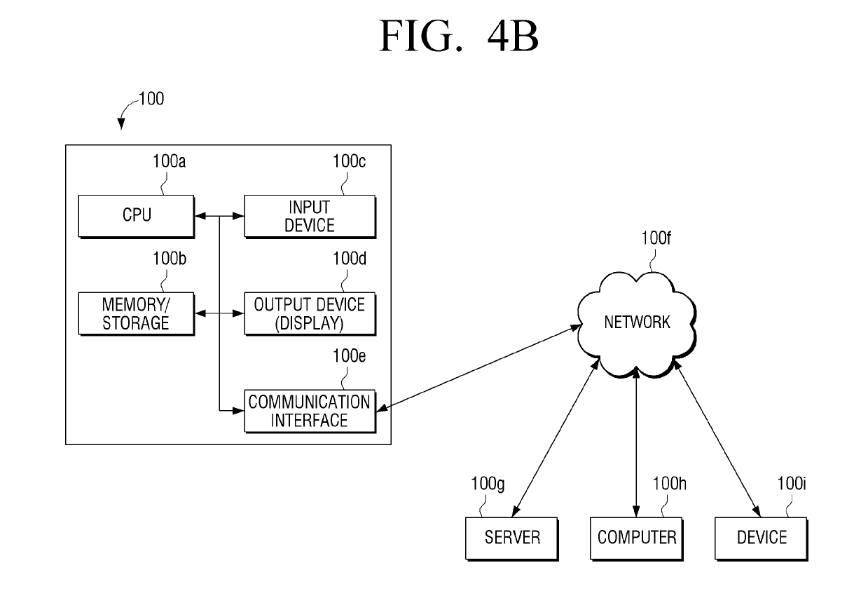

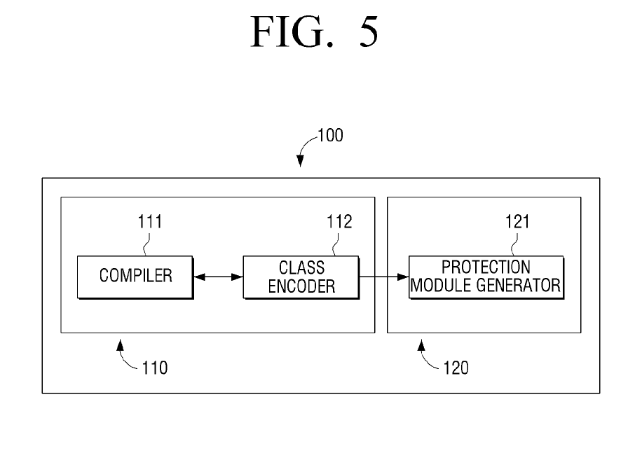

FIGS. 4A, 4B, and 5 are block diagrams illustrating an example of a device 100 to generate an application execution file according to an exemplary embodiment of the present general inventive concept. The device 100 may be a mobile device and/or a computing device. That is, the device 100 may be, for example, a smartphone, a tablet computer, a laptop computer, a multimedia player, and/or any other suitable mobile and/or portable device. Alternatively, the device 100 may be a computer and/or a server.

Referring to FIG. 4A, a device 100 to generate an application execution file according to an exemplary embodiment of the present general inventive concept includes an encoder 110 that encodes some of the classes, and an application generator 120 that generates an execution file. The encoder 110 can be, for example, an integrated circuit, a processor, a field programmable gate array, or a programmable logic device. Similarly, the application generator can be, for example, an integrated circuit, a processor, a field programmable gate array, or a programmable logic device. Referring to FIG. 5, the encoder 110 includes a compiler 111 that compiles a source code and a class encoder 112 that encodes one or more classes, and the application generator 120 includes a protection module generator 121.

The encoder 110 encodes at least one class which requires security, independently of other classes among a plurality of classes to execute an application. The compiler 111 included in the encoder 110 generates an execution file by compiling a written source code. The generated execution file includes a plurality of classes to execute an application. The class encoder 112 encodes the at least one class which requires security among the plurality of generated classes.

The class encoder 112 may encode classes by using one or more encoding algorithms. That is, the class encoder 112 may use any one or more of a symmetric key algorithm and a public key algorithm. For example, any one of Academy Research Institute Agency (ARIA) algorithm, Data Encryption Standard (DES) algorithm, Advanced Encryption Standard (AES) algorithm, SEED algorithm, and Rivest-Shamir-Adleman (RSA) algorithm may be used by the class encoder 112 to encode classes that require security.

The ARIA algorithm suggested by the National Security Research Institute of Korea has a block size of 128 bits and key sizes of 128, 192, and 256 bits. The ARIA algorithm has a characteristic that the number of rounds is 12, 14, and 16, depending on the key size of 128, 192, and 256 bits, respectively.

The DES algorithm adopted by the U.S. Department of Defense is a private key algorithm, and has a block size of 64 bits and a key size of 56 bits. The AES algorithm, which was developed to resolve the vulnerabilities of the DES algorithm, has a block size of 128 bits and variable key lengths of 128, 192, and 256 bits. The SEED algorithm, which is a Korean standard symmetric key algorithm, encodes data of 8, 16, and 32 bits in 16 rounds using a 128-bit key, and is mostly used for encoding authenticated certificates. The RSA (Rivest-Shamir-Adleman) algorithm is a public-key based algorithm, and is mostly widely used. Developed by considering that it is difficult to factorize composite numbers, which are composed of very large prime numbers, the RSA algorithm is based on a trapdoor function in which a reverse function of an encryption function is hard to obtain and/or determine.

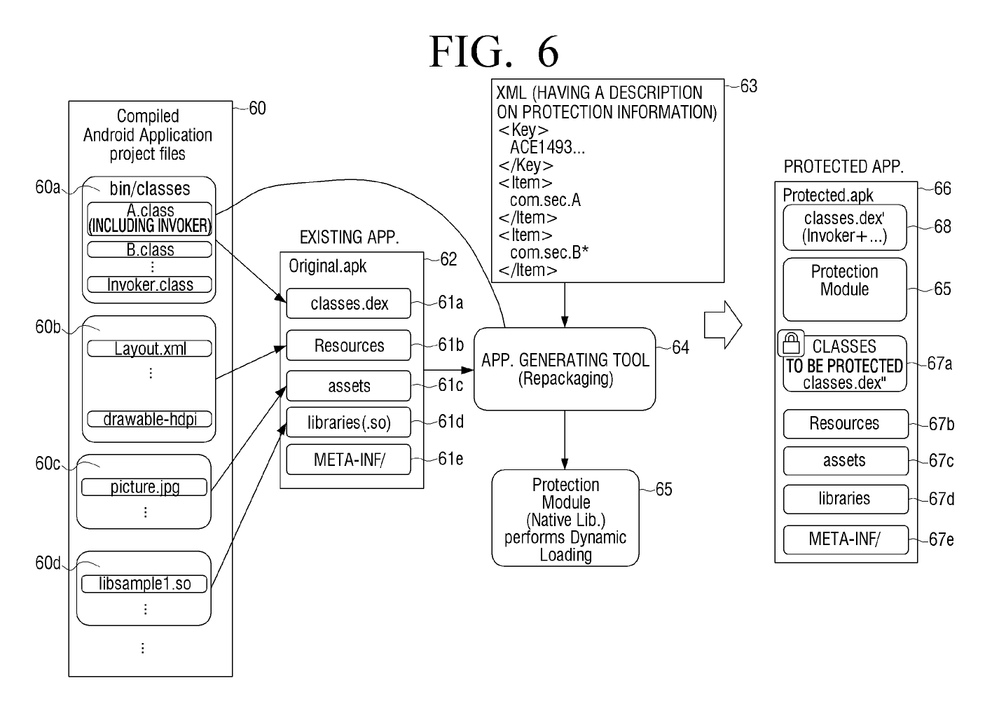

The application generator 120 generates the application execution file which includes the encoded at least one class and the other classes. The application generator 120 includes the protection module generator 121 to generate a protection module to identify the at least one class that requires security by reference to protection class information (e.g., by referring to XML file 63 illustrated in FIG. 6 and described below).

Herein, the protection class information refers to information to identify which class is to be protected. The protection class information may be written in a markup language, such as XML (eXtensible Markup Language), by a user input. The device to generate an application execution file (e.g., the application generator 120 of the device 100 illustrated in FIG. 4A) separates classes to be protected from other classes by reference to the protection class information thus written (e.g., by referring to XML file 63 illustrated in FIG. 6 and described below). If each configuration of the device 100 to generate an application execution file is included as the function of an application generating tool (e.g., application generating tool 64 illustrated in FIG. 6 and described below; the application generating tool is controlled and/or executed by the application generator 120), the application generating tool performs each configuration as described above.

The generated protection module (e.g., the protection module 65 illustrated in FIG. 6 and described below, that is generated by the protection module generator 121 illustrated in FIG. 5) is included in an execution file, and includes a key for decoding the encoded class. The decoding key is then encoded again, thereby increasing and/or enhancing security.

Referring to FIG. 4B, the device 100 to generate an application execution file may include a configuration of a calculating apparatus. That is, such configuration may include a hardware configuration including a CPU (central processing unit) 100a having a sufficient control and computing capacity, a large capacity auxiliary storage device 100b such as cache memory, RAM memory (Random Access Memory), a hard disc, a solid state drive (SSD), an optical disc, or a blue-ray disc, an input device 110c (e.g., a touchpad, a touch screen, one or more buttons, a rotational wheel, etc.) and output device 100d (e.g., a display screen, a touch screen, etc.), and a communication interface 100e that may include various types of wire and wireless communication interfaces having a short-distance and/or long distance communication module and an HDMI (High-Definition Multimedia Interface), data bus, etc., as well as a framework for the operation of the execution file and an operating system. The device 100 may communicate with one or more devices coupled to a communications network 100f via the communication interface 100e . That is, the device 100 can communicate with a server 100g, a computer 100h, and/or another device 100i . Although only the server 100g, computer 100h, and device 100i are illustrated, other similar devices may be connected to the communications network 100f . As an alternative to the CPU 100a, a programmable logic unit, a field programmable gate array, an integrated circuit, and/or any other suitable processor may be used. Also, the input device 100c and the output device 100d may be combined. For example, a touch screen may receive user input, as well as output information on a display of the touch screen.

The server 100g may provide one or more services to the device 100, where the services may include purchasing, banking, financial, investment, and/or medical related services that may exchange sensitive and/or personal data with the user of the device 100.

Further, an environment to operate the device to generate an application execution file may be provided. For example, when the device to generate an application execution file is embodied in a program developing tool, the system may provide an emulator or a simulator. The emulator and/or simulator may be included in the CPU 100a . Alternatively, the emulator and/or simulator may be a programmable logic unit, a field programmable gate array, an integrated circuit, and/or any other suitable processor.

Hereinafter, in an exemplary embodiment of the present general inventive concept, an example of generating an execution file with a device (e.g., the device 100 illustrated in FIGS. 4A, 4B and 5) which includes a class encoded based on a compiled JAVA source code will be described.

FIG. 6 is a schematic view illustrating an example of generating an execution file which includes an encoded class.

A source code 60, which is written initially (e.g., in JAVA), includes classes 60a (bin/classes), resources 60b (res), assets 60c and libraries 60d (libs). When a compiler (e.g., compiler 111 of the device 100 illustrated in FIG. 5 and described above) compiles a JAVA source code (e.g., the source code 60), an application execution file 62 is generated, and the generated application execution file 62 includes classes.dex 61a (i.e., the classes for the application execution file 62), resources 61b, assets 61c, libraries 61d (.so) and META-INF/61e (an internal JAVA meta-directory). The device to generate an execution file (application generating tool 64, that is controlled and/or executed by the application generator 120 of the device 100) according to the present general inventive concept separates classes to be protected (e.g., the protected classes of the classes.dex file 67) in the compiled application (e.g., application execution file 62) from other classes by reference to an XML file 63 having a description on protection information, which is then added to assets in a separate file (e.g., a protected application 66), or a protected classes.dex file 67a (and/or other classes to be protected) may be generated separately. Further, a classes.dex file 68, which does not need protection, is generated (including an Invoker) with the application generating tool 64 to replace the existing classes.dex 61a . The application generating tool 64 (e.g., that is controlled and/or executed by the application generator 120 of the device 100) generates the protection module 65, prepares a list of classes to be protected by the protection module 65 (e.g., by using the XML file 63) and adds the list to the protected application 66. The generated protected application includes the protected classes.dex file 67a (i.e., the classes to be protected), resources 67b, assets 67c, libraries 67d, and META-INF/67e, along with the protection module 65 and the classes.dex file 68 (i.e., the unprotected classes). The protection module 65 is configured to dynamically load a compiled execution file (e.g., the protected application 66) by a JAVA virtual machine (JVM), such as Dalvik or JVM.

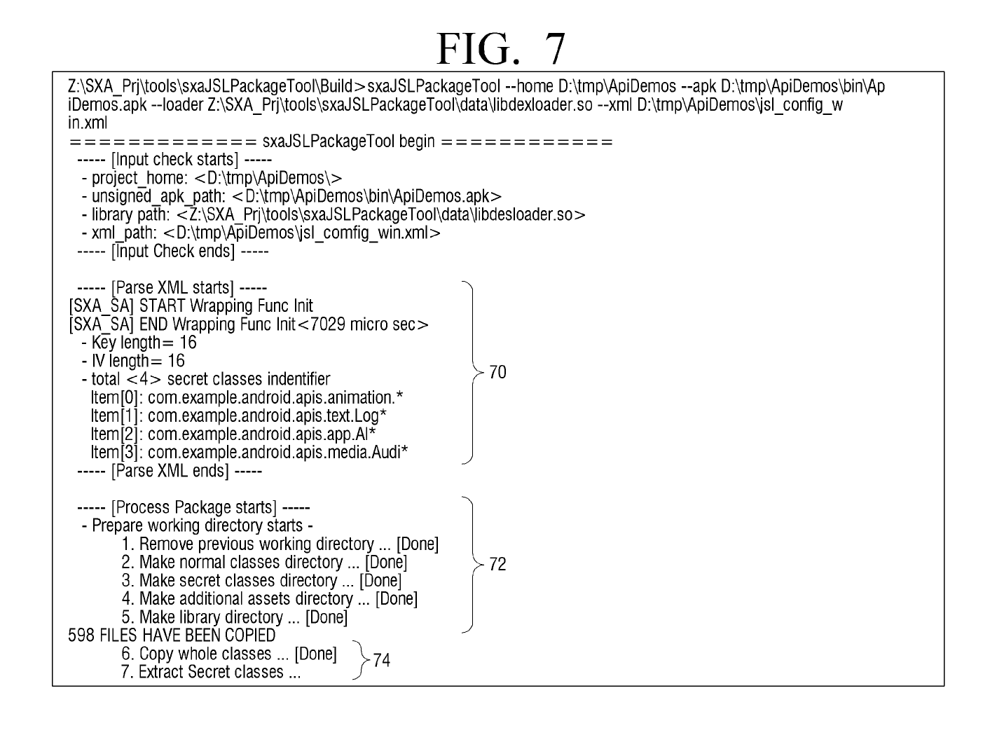

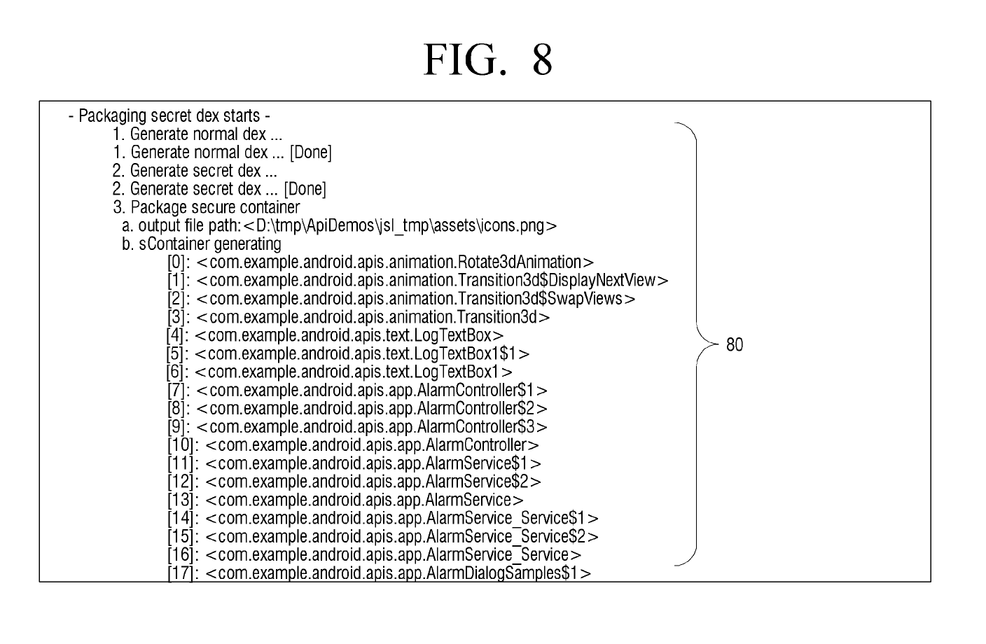

FIGS. 7 and 8 are views illustrating an executing screen of a tool that generates an execution file (e.g., the application generating tool 64 as illustrated in FIG. 6 and described above) including an encoded JAVA class.

As illustrated in FIGS. 7 and 8, the execution file generating tool parses an XML file, in which protection class information is recorded, so as to generate an execution file including an encoded JAVA class. After identifying secret classes through the parsing at operation 70, the generation of the execution file begins at operation 72, in which normal classes and secret classes are generated in a separate directory, and at operation 74, the generated directories are copied. As illustrated in operation 80 of FIG. 8 encoding is performed for the classes to be protected.

As described above, in the present general inventive concept, classes to be protected in an application written in a managed code are separately encoded to generate an execution file. Accordingly, a file with security is generated such that there is an increased difficulty in decompiling the file, thereby increasing the security of an application of a mobile device. By separately encoding the classes to protected in the application, developers do not have to change a source code into a Native code. This minimizes bugs and/or other coding errors that may occur during the changing process into a Native code. In addition, as described below, the present general inventive concept employs a dynamic loading, which enables reference to an external class without using a Reflection function, such that a resource overhead normally caused by the use of a Reflection function does not occur.

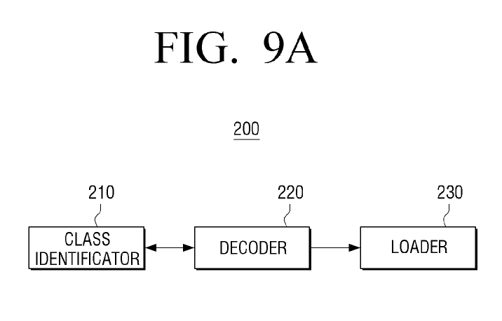

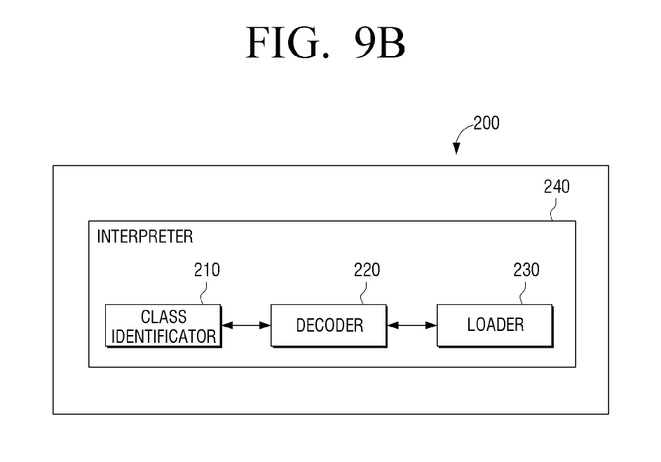

Hereinafter, the structure and operation of a mobile device 200 (e.g., as illustrated in FIGS. 9A-9B) in which an application generated by the device 100 to generate an application execution file can be installed and executed.

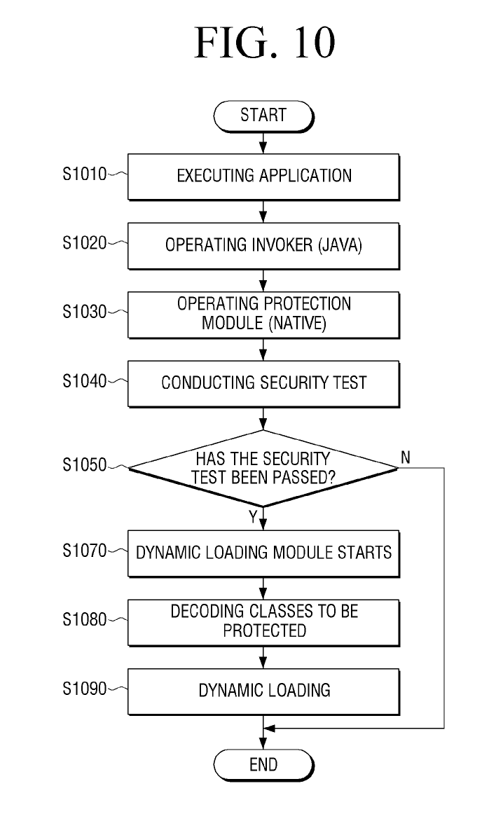

FIGS. 9A-9B are block diagrams illustrating examples of a mobile device 200 according to exemplary embodiments of the present general inventive concept, and FIG. 10 is a flow chart illustrating an operation of the mobile device.

Referring to FIG. 9A, the mobile device 200 includes class identificator 210, a decoder 220 and a loader 230. The class identificator 210, the decoder 220, and loader 230 may be separate integrated circuits, processors, field programmable gate arrays, and/or programmable logic devices. Alternatively, one or more of the class identificator 210, the decoder 220, and loader 230 may be combined in an integrated circuit, processor, field programmable gate array, and/or programmable logic device. The mobile device 200 may be and/or include the features of device 100 illustrated in FIGS. 4A, 4B, and 5, and as described above.

The class identificator 210 can identify a class that requires security. That is, when receiving an application execute command, the class identificator 210 identifies at least one class which requires security among the application classes. For example, the class identificator 210 may use descriptions on protection information (e.g., XML file 63 and/or the protection module 65 illustrated in FIG. 6) stored in a memory to identify the at least one class that requires security.

When there is an execute command with the application installed in a mobile device (e.g., when the mobile device receives a user input to execute the application), the class identificator 210 identifies at least one class which requires security by reference to protection class information. The class identification 210 may be configured as part of the protection module (e.g., the protection module 65 illustrated in FIG. 6).

The decoder 220 can decode the identified class. Specifically, the decoder 220 decodes the identified class using a pre-stored key. The key may be stored by multi-layered encryption, and the decoder 220 decodes the identified class using a key which is delivered by various key delivering techniques. Further, one or more tests may be performed for the decoded class. For example, the types of encoded classes and the number of encoded classes may be checked to see whether the decoding is performed normally. Error correction may be performed by the decoder 220, or alternatively, a separate error correction device, when it is determined that there has been an error in the decoding of the one or more identified classes. The decoder 220 may also be configured as part of the protection module (e.g., the protection module 65 as illustrated in FIG. 6 and described above).

The loader 230 can dynamically load the decoded at least one class. When executing an application program normally, the loader 230 loads a class which is not decoded, that is, does not require security, since a start class is included in a class group which does not require security. However, while executing the application program, if there is a class which requires security, that is, if there is a reference of a decoded class, the decoder 230 loads the decoded class in a memory of the mobile device 200.

The dynamic loading, which performs loading when a class is to be used, allows the memory space to be used effectively, and capacity can be increased compared to using a Reflection function. That is, without using a Reflection function, a class that requires security is managed separately, and decoded only when executing an application for memory loading, thereby reducing and/or eliminating security vulnerability, and minimizing and/or preventing overhead occurred when using a Reflection function.

The mobile device 200 may be configured to include a configuration of a common calculating apparatus, as similarly described above in connection with the device 100 that is illustrated in FIGS. 4A, 4B, and 5. That is, such configuration may include a hardware configuration including a CPU, processor, integrated circuit, field programmable gate array, and/or programmable logic device having a control and computing capacity, a storage device such as cache memory, RAM memory, a hard disc, solid state drive (SSD), optical disc, and/or a blue-ray disc, an input and output device such as a touch screen, various types of wire and wireless communication interfaces having a short-distance and log-distance communication modules and an HDMI, data bus, etc., as well as a framework for the operation of the execution file and an operating system.

Specifically, as illustrated in FIG. 9B, the mobile device 200 may include an interpreter 240 that performs the functions of the class identificator 210, the decoder 220, and the loader 230. For example, the mobile device 200 may include a JAVA virtual machine, such as Dalvik or JVM as the interpreter 240. Alternatively, the interpreter 240 may include the class identificator 210, the decoder 220, and loader 230 that are combined in an integrated circuit, processor, field programmable gate array, and/or programmable logic device as the interpreter 240.

FIG. 10 is a view illustrating an example of an operation of the JAVA virtual machine of the present general inventive concept. The JAVA virtual machine may be included with the device 100 and/or the mobile device 200 as described above and as respectively illustrated in FIGS. 4A, 4B, 5, and 9A-9B.

In FIG. 10, when a JAVA application is executed at operation S1010 (e.g., upon receiving input from a user of device 100 or mobile device 200), the JAVA virtual machine operates an Invoker at operation S1020 to operate the protection module at operation S1030. The invoker may be part of the classes.dex 68, and the protection module may be the protection module 65 illustrated in FIG. 6 and described above. The protection module or class may tested for security at operations S1040 and S1050, and after passing the test, a dynamic loading module may load the selected application program to be executed at operation S1070. Decoding is performed for classes to be protected at operation S1080, and the dynamic loading is performed at operation S1090. That is, operations S1040 and S1050 determine whether there are classes to be protected, and, if so, the protected classes are decoded at operation S1080, and the application can be dynamically loaded with the decoded protected classes at operation S1090. If it is determined at operation S1050 that the security test has not been passed (i.e., that there are no protected classes), the operation of the JAVA virtual machine operates normally, as there are no protected classes to be decoded.

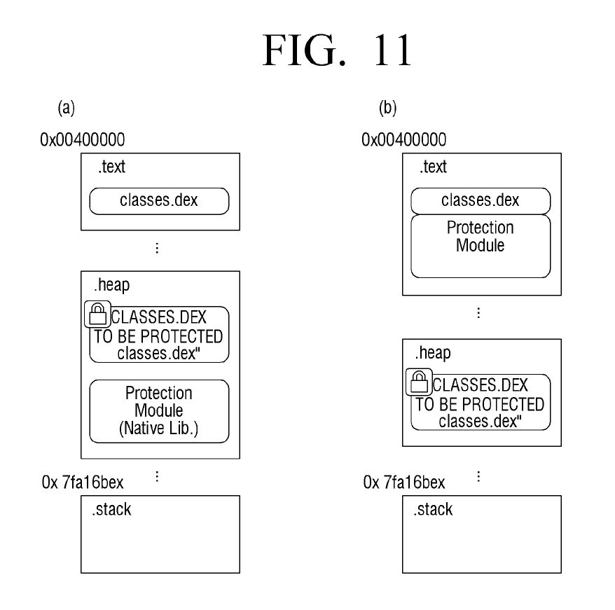

The classes to be protected may be written in a Native code, instead of a managed code. FIG. 11 is a view illustrating such an example.

That is, FIG. 11 is a schematic view illustrating an example of writing one or more classes to be protected in a Native code.

In the exemplary embodiment (a) of FIG. 11, as in the same manner as described above, classes to be protected are written in a managed code. In this case, the protection module and the classes to be protected are stored in a heap area of a memory, which is in accordance with a dynamic loading. As described above, having the classes to be protected written in a managed code (i.e., instead of the native code) may produce errors and/or bugs, and may increase and/or delay application program development.

In the exemplary embodiment (b) of FIG. 11, the protection module is stored in a text area of a memory of a mobile device (e.g., device 100 illustrated in FIGS. 4A, 4B, and 5, and/or mobile device 200 illustrated in FIGS. 9A-9B). However, classes to be protected are written in a Native language, and assigned to a heap area. In this case, security is increased, as classes to be protected are written in a Native code, and then can be encoded. Moreover, as the protected classes are in the Native code, application developers do not have to convert the classes to a managed code, which may result in bugs and/or errors, and which may increase application development time.

Hereinafter, a method of generating an application execution file for a mobile device according to various embodiments of the present general inventive concept will be described.

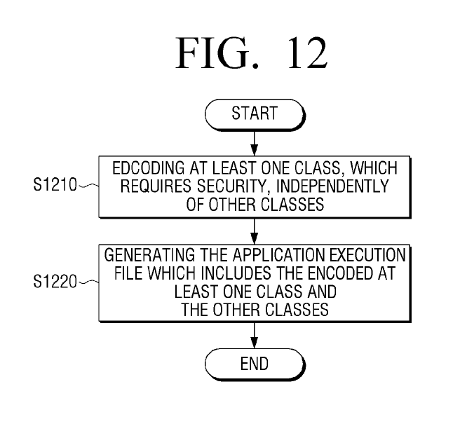

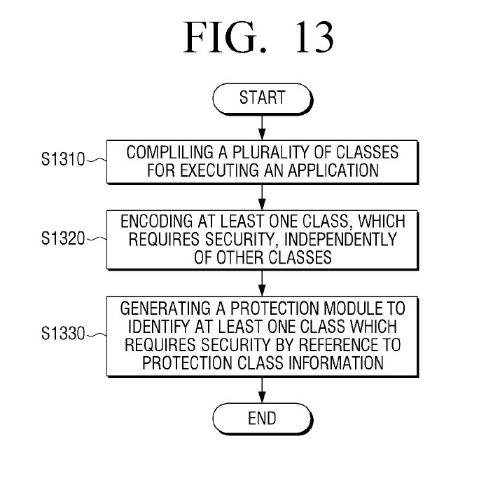

FIGS. 12 and 13 are flow charts illustrating examples of methods of generating an application execution file for a mobile device according to various embodiments of the present general inventive concept.

Referring to FIG. 12, the method of generating an application execution file for a mobile device (e.g., device 100 illustrated in FIGS. 4A, 4B, and 5 and as decribed above, and/or mobile device 200 illustrated in FIGS. 9A-9B and described above) according to various embodiments of the present general inventive concept includes encoding at least one class which requires security, independently of other classes among a plurality of classes for executing the application at operation S1210, and generating the application execution file which includes the encoded at least one class and the other classes at operation S1220.

Referring to FIG. 13, the encoding (e.g., operation S1210 of FIG. 12) may include compiling a plurality of classes to execute the application at operation S1310, and encoding the at least one class which requires security, separately from the other classes among the plurality of compiled classes. The encoding may include generating protection class information (e.g., generating the XML file 63 illustrated in FIG. 6 and described above) including information on the at least one class which requires security at operation S1320, and generating a protection module (e.g., protection module 65 illustrated in FIG. 6 and described above) to identify the at least one class which requires security at operation S1330 by reference to the generated protection class information (e.g., generating the XML file 63 illustrated in FIG. 6 and described above), when executing an application.

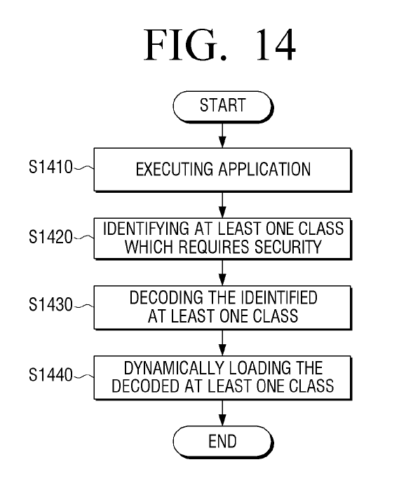

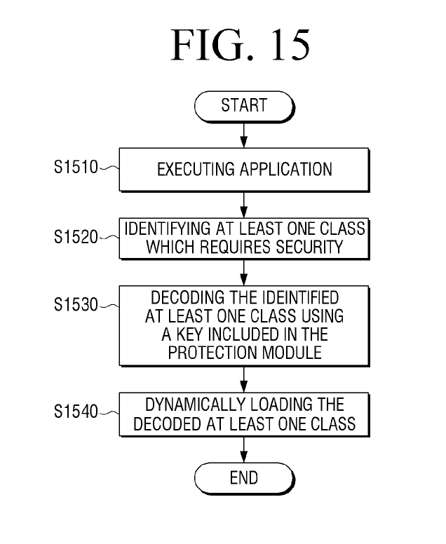

FIGS. 14 and 15 are flow charts illustrating examples of methods of executing an application of a mobile device according to various embodiments of the present general inventive concept.

Referring to FIGS. 14 and 15, the methods of executing an application of a mobile device according to various embodiments of the present general inventive concept include when receiving an application execute command at operation S1410 or operation S1510, identifying at least one class which requires security at operation S1420 or operation S1520, decoding the identified at least one class at operation S1430, and dynamically loading the decoded at least one class at operation S1440 or S1540. As described above, a class may be identified as being a protected class, and thus requiring security. When such classes are identified, these protected classes are decoded, and the program application can be dynamically loaded and executed.

That is, the identifying at least one class at operation S1420 and/or at operation S1520 may identify at least one class that requires security by reference to protection class information (e.g., the XML file 63 illustrated in FIG. 6 and described above).

The operation of decoding the identified at least one class (e.g., in operations S1430 and S1530) may decode the identified at least one class using a key included in the protection module at operation S1530. The protection module with the key may be protection module 65 as illustrated in FIG. 6 and described above.

The method of generating an application execution file for a mobile device and the method of executing an application of a mobile device as mentioned above may be stored in a non-transitory computer-readable recording medium as a program.

Herein, the non-transitory readable medium refers to a medium that stores data semi-permanently, not for a short time, such as a register or cache, and can be read through an electronic apparatus. Examples of the non-transitory readable medium include CD, DVD, hard disc, blue-ray disc, USB, memory card, ROM, etc.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Further, the method of generating an application execution file for a mobile device and the method of executing an application of a mobile device as mentioned above may be provided as a software embedded in an IC chip of hardware, or may be configured in the device 100 to generate an application execution file or in the mobile device 200.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of generating an application execution file for a mobile device, comprising:
encoding at least one class, which requires security, independently of other classes among a plurality of classes with an encoder of the mobile device to execute the application; and
generating the application execution file which includes the encoded at least one class and the other classes with an application generator of the mobile device.

2. The method as claimed in claim 1, wherein the encoding comprises:
compiling a plurality of classes to execute the application; and
encoding the at least one class, which requires security, separately from the other classes among the plurality of compiled classes.

3. The method as claimed in claim 1, further comprising:
generating protection class information including information on the at least one class which requires security; and
generating a protection module to identify the at least one class which requires security by reference to the generated protection class information, when executing the application.

4. A method of executing an application of a mobile device, comprising:
identifying at least one class which requires security when receiving a command to execute the application;
decoding the identified at least one class with a decoder of the mobile device; and
dynamically loading the decoded at least one class.

5. The method as claimed in claim 4, wherein the identifying at least one class identifies the at least one class which requires security according to protection class information.

6. The method as claimed in claim 4, wherein the decoding the identified at least one class decodes the identified at least one class using a key included in a protection module of the application.

7. A program developing tool to perform the method of generating an application execution file for a mobile device as claimed in claim 1.

8. A device to generate an application execution file for a mobile device comprising:
an encoder to encode at least one class, which requires security, independently of other classes among a plurality of classes for executing the application; and
an execution file generator to generate the application execution file which includes the encoded at least one class and the other classes.

9. The method as claimed in claim 8, wherein the encoder comprises:
a compiler to compile a plurality of classes for executing the application; and
a class encoder to encode the at least one class, which requires security, separately from the other classes among the plurality of compiled classes.

10. The method as claimed in claim 8, wherein the execution file generator comprises:
a protection module generator to generate a protection module to identify the at least one class which requires security.

11. A mobile device, comprising:
a class identificator to identify at least one class which requires security among a plurality of application classes of an application, when receiving an application execute command with the mobile device;
a decoder to decode the identified at least one class; and
a loader to dynamically load the decoded at least one class.

12. The mobile device as claimed in claim 11, wherein the class identificator identifies the at least one class which requires security according to protection class information.

13. The mobile device as claimed in claim 11, wherein the decoder decodes the identified at least one class using a key included in a protection module of the application.

14. A mobile device, comprising:
an interpreter to identify at least one class which requires security among a plurality of application classes of an application, when receiving an application execute command with the mobile device, to decode the identified at least one class, and to dynamically load the decoded at least one class.

15. A computing device, comprising:
an encoder to determine a least one class, from a plurality of classes, which requires security for an application execution file to be generated by the computing device, and to encode the determined at least one class which requires security independently of other classes among the plurality of classes; and
an execution file generator to generate the application execution file which includes the encoded at least one class and the other classes.

16. A computing device, comprising:
a processor to identify at least one class which requires security among a plurality of application classes of a selected application to be executed by the computing device upon receiving an execution command;
a decoder to decode the identified at least one class that requires security; and
a loader to dynamically load the decoded at least one class,
wherein the processor executes the selected application according to the plurality of application classes and the decoded at least one class that requires security that is dynamically loaded.
